(19) United States
(12) Patent Application Publication
(10) Pub. No.: US 2001/0043566 A1
(43) Pub. Date: Nov. 22, 2001

(54) Control signal system in switch

(75) Inventor: Yu-Chun Chow, Hsinchu (TW)

Correspondence Address: Klein & Szekeres, LLP, 4199 Campus Drive, Suite 700, Irvine, CA, 92612, US

(73) Assignee: ADMtek Incorporated Ltd.

(21) Appl. No.: 09/854,712

(22) Filed: May 14, 2001

(30) Foreign Application Priority Data
May 19, 2000 (TW) 89109723

(51) Int. Cl. G01R 31/08; G06F 11/00

(52) U.S. Cl. 370/235; 370/230; 370/428

(57) ABSTRACT

A flow control signal system in a switch and a processing method for a flow control signal system to control the data packets transmitted in network is disclosed. The flow control signal system in a switch includes an empty buffer counter, N port-packet-counters and N alarm units therein. And a processing method is also provided, which includes steps of sending and storing the data packet into a switch, respectively computing the both values of the empty buffer counter and the port-packet-counters, alarming an alarming state for informing a port in the switch will be overfilled with the data packets, triggering one of (N−1) alarm units for stopping other data packets from source ends connected with the another ports in network to be transported to the switch and running the steps disclosed in the present invention to process the data packets until all data packets in the switch have been processed.

### FIELD OF THE INVENTION

The present invention relates to a flow control system for controlling data packets transmitted between different ports in a switch, especially to a controlling method for a flow control system to transmit the data packets among different terminal ends and peripheral equipments.

### BACKGROUND OF THE INVENTION

Network transmission have been commonly and massively used by business administrators and general users. The purposes of sharing the resources in a network and exchanging information among a lots of servers can be easily achieved by properly linking the digital data processing systems and dispersed computers into a digital conmmunication network. Among the exchanging equipments, a network switch is one of the most important devices for communicating and coordinating the information among different terminal nodes in the network. In a prior art, a buffer in a switch is provided for transmitting and storing the data packets come from the network and passed through the switch to be exchanged among different terminals. Each of the data packets usually includes a source port coding number, a data information itself and a destination port coding number therein and can be provided as an information to be processed and error detected by the switch. Consequently, a buffer management scheme in the switch is performed for avoiding error transmitting so as to increase the transmitting efficiency of the data packets. The operating processes of the buffer management scheme are described as steps: (1) storing and processing data packets in buffer, (2) reading and managing data packets in a output buffer, (3) processing the addresses of the stored data packets to be read, (4) maintaining the data packets in the output buffer from being rewritten until the data packets being read out, (5) preventing the data stream from the network from congesting in the switch when the data packets are inputted at a disproportionate rate and (6) sending a signal to control the switch according to the situation of the buffer management.

FIG. 1 illustrates a block diagram of a switch management system for controlling the data flow according to prior art. For example, in such a traditional network switch including N input/output ports, the data communication and transmitting among network nodes, e.g. computers, are performed by sing the network switch. The data is transmitted in the form of data packets which include a source port coding number, the data itself and a destination port coding number. And the traditional switch management system could decide whether the data packets can be sent to the switch according to the source port coding number prerecord in the data packet to be judged by the switch to find out where the data packet come from, where the data packets to be sent to and how much does the influx of the data packets run into the switch. In FIG. 1, an empty buffer counter 10 counts is used to count the number of the empty buffer in the switch for preventing too much data packets from sending into the switch. In addition, in the traditional switch control system has port packet counter sets provide in accordance with the destination port cording number. Each set is performed by N−1counters, for example, the port packet counter 110 is used for counting the numbers of the data packets to be sent from other source ports into input the port 1 except for input port 1 itself. The N−1 port-to-port counters , i. e. the port 2 to port 1 counter 21, port 3 to port 1 counter 31, . . . , and port N to port 1 counter N1 are used for respectively counting the number of the data packets in the switch to be sent into the port 1. When the counting value of the port 1 packet counter 110, (i. e. the summation of counter 21, counter 31, . . . , and counter N1) is greater than a threshold value A preset and the value of counter 21 is greater than threshold B, a signal will be triggered the port 1 to stop transmitting the data packets into the network switch via the post 2 flow controller 611.

However, the network switch of the prior art needs an empty buffer counter 10 and N (N−1) counters (i. e. N port packet counters set multiply (N−1) port-to-port packet counters) to accomplish the functions of flow control. Furthermore, the flow control method is not correctly and quickly performed in real time for responding to the state of the flow rate and the flow direction of the data packets.

Therefore, it is attempted by the applicant to provide a flow control signal system in a switch and method for overcoming the problems happened in the prior art.

### SUMMARY OF THE INVENTION

It is therefore an object of the present invention to provide an apparatus and a method for generating a flow control signal, thereby preventing the data packets from congestion in a network switch.

It is therefore another object of the present invention to provide a real-time control mechanism for efficiently transporting data packets in a network switch.

According to the present invention, there is provided an apparatus of flow control signal system in a switch which includes N numbers of ports and a buffer stack. The flow control signal comprises an empty buffer counter, N numbers of port-packet-counters and N numbers of alarm units.

Preferably, the buffer stack further comprises a plurality of buffer implements. Each of said buffer implements is for receiving and storing a data packet sent from network to be sent to one port in the switch.

Preferably, the empty buffer counter is for recording the residual value of the empty number in the buffer stack. And one of the port-packet-counters is for recording the number of data packets regarded to be send to the port in the switch.

Preferably, one of said N numbers of alarm units is for responding to an information brought form said data packet.

Preferably, N numbers of alarm units further comprises N numbers of comparators and N numbers of signal generators. Each of said N numbers of comparators is for sending an triggering message to one of N numbers of signal generators after an alarming stage is announced. One of the N numbers of signal generators is triggered by said triggering message for sending a flow control signal to one of N numbers of ports.

According to another aspect of the present invention, there is provided a generating method of the flow control signal system in a switch which has N numbers of ports and a buffer stack therein. The present method comprises a step (a) of sending a data packet to be sent to a port from a network and storing the data packet into one of a plurality of buffer implements disposed in the buffer stack, a step (b) of deducting 1 from an empty buffer counter disposed in the switch and adding 1 to one of N numbers of port-packet-counters corresponding to the port set in the flow control signal system, a step (c) of respectively computing whether both values of the empty buffer counter and the port-packet-counters is less than a buffer-examined threshold and greater than a port-packet-examined threshold, a step (d) of announcing an alarming state for informing that the data packets from network to be sent to the port will be filled, a step (e) of finding a second data packet from another port to be sent to the port, a step (f) of sending and storing the second packet into another buffer implement of the buffer stack, and triggering one of (N−1) alarm units corresponding to the another port for stopping other data packets from source ends connected with the another ports in network transporting to the switch and a step (g) of back to step (a) after the alarming stage is removed, repeating the steps as described above to process the data packets to be sent to the port until all data packets in the switch have been processed.

Preferably, before said step (a) further comprises a step of transporting the data packet from a network to the switch.

Preferably, the empty buffer counter and one of N numbers of port-packet-counters in step (b) are respectively for recording the residual value of the empty number in the buffer stack and recording the number of data packets to be send to the port.

Preferably, before the step (c) further comprises a step of examining N numbers of ports but except for the port. And the buffer-examined threshold in the step (c) is defined by presetting a value by a user. The port-packet-examined threshold in the step (c) is defined by presetting another value by a user.

Preferably, the alarming stage in step (d) is announced by N numbers of alarming units set in the flow control signal system but except one corresponding to the port. The step (f) further comprises steps of a comparing step and a triggering step respectively for one of N numbers of comparators set in the flow control signal system to compare the values in step (c) and one of N numbers of signal generators set also in the flow control system to trigger an triggering message to be sent to another port.

Preferably, the triggering message is for stopping the network connected to another port transporting the data packets to the switch as defined in the step (f).

According to the present invention, there is another object provided a medium of flow control signal system for a switch to process comprising of a routing means for causing the switch to receive a data packet to be sent to a port from a network and store the data packet in the switch, a counting means for causing the switch to deduct 1 from an empty buffer counter disposed in the switch and add 1 to one of N numbers of port-packet-counters corresponding to port set in the flow control signal system, a computing means for causing the switch to respectively count both values of the empty buffer counter and the port-packet-counters, an alarming means for causing the switch to announce an alarming stage for noting that the data packets to be sent to the port will be filled, an examining means for causing the switch to find another data packet from another port to be sent to the port, a triggering means for causing the switch to trigger an message to stop other data packets to be transported to said port transporting to the switch in network and a transporting means for causing the switch to circularly process and transport the data packets to be sent to said primary port until all data packets in the switch have been processed.

The aforementioned and other features and subjects of the present invention and the manner of attaining them will become more apparent and the invention it self-will be better understood by reference to the following description a preferred embodiment taken in conjunction with the companying drawings, wherein:

### BRIEF DESCRIPTION OF THE DRAWINGS

FIG. 1 shows a switch management system for controlling the data packets flow according to the prior art;

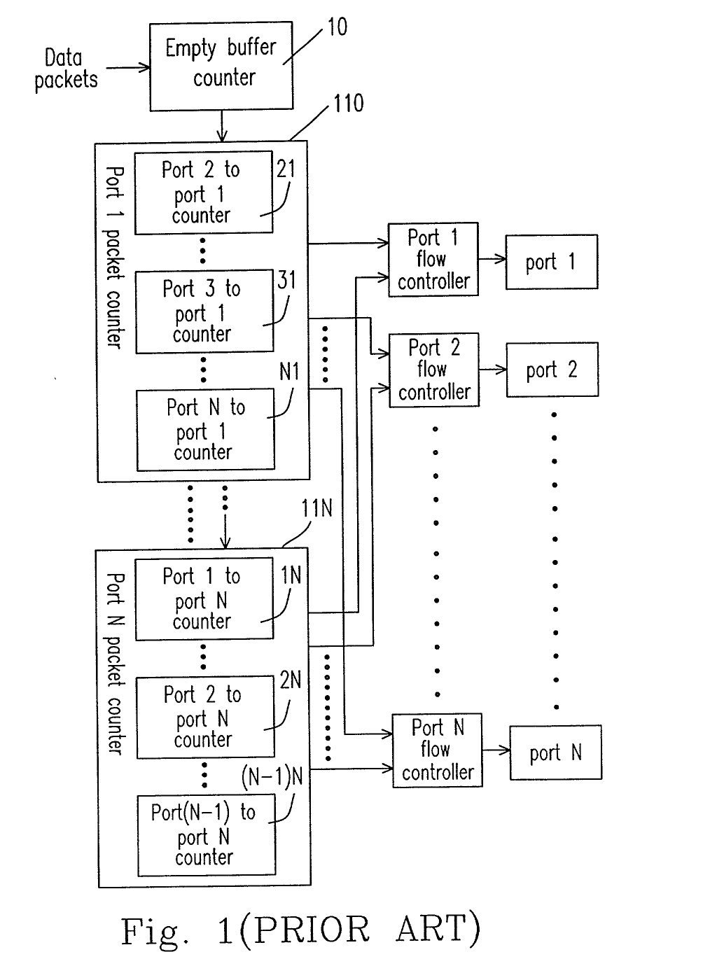

FIG. 2 shows a preferred flow control signal system in a switch for transmitting the data packets among the different terminal ends; and

FIG. 3 shows a preferred flowchart for a flow control signal system in a switch to control the flux of the data packets.

### DETAILED DESCRIPTION OF THE PREFERRED EMBODIMENT

A data packet usually includes a source port coding number, the data itself and a destination port coding number.

The usage of the apparatus according to the present invention will be understood more clear by the following abbreviates: a flow control signal system abbreviated as FCSS is used for controlling and preventing the data packets to be transported to a switch from being congested in network, an empty buffer abbreviated as EBC is used for counting how much space a buffer remains available, a port packet counter abbreviated PPC is used for counting how much space in a buffer remains available, a buffer threshold abbreviated BT for denoting a minimum safety level for allowing of data packets to be sent to a switch, and port threshold abbreviated PT is used for denoting a maximum safety level for allowing of data packets to be sent to one of N ports in a switch.

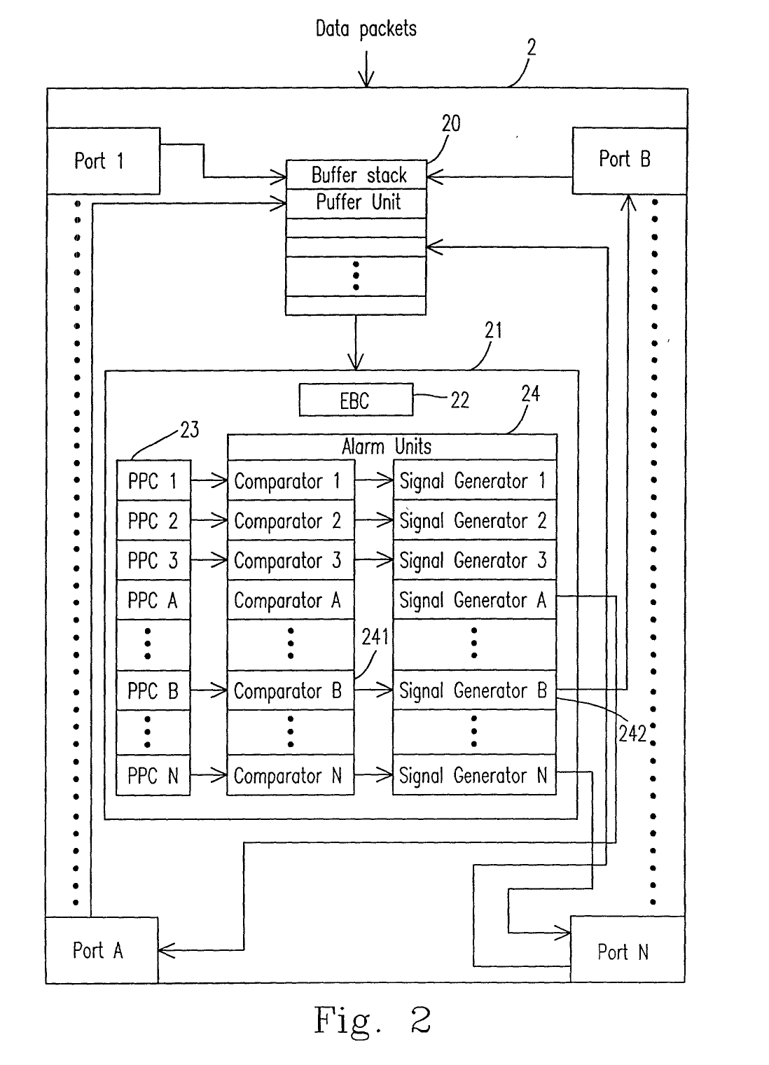

FIG. 2 shows a preferred flow control signal system in a switch 2 for transmitting the data packets among the different terminal ends. The switch 2 includes N ports having port 1, port 2, . . . , and port N, a buffer stack 20 consisting of a plurality of buffer units and a flow control signal system 21. The flow control signal system 21 further includes an empty buffer counter (EBC) 22, N port packet counters (PPC) 23, and N alarm units 24 therein. The N alarm units further includes N comparators 241 and N flow control signal generators 242 corresponding to ones of the N comparators.

A flow control signal system (FCSS) 21 in FIG. 2 includes an empty buffer counter(EBC) 22, N number of port packet counters (PPC) 23 from PPC1, PPC2, . . . , to PPC N and N numbers of alarm units 24. The EBC 22 will count how much space available in the buffer stack by deducting 1 from the EBC. In other word, the EBC 22 down-count the number of the data packets come from any port of the network so as to have the minimum safety level to be a buffer threshold (BT) for allowing the data packets to be sent to the switch as described above. At the same time, one of PPC 23 will count the number of data packets regarded to be sent to one of N ports except the number corresponding to the one of N ports by adding 1 to the one of the PPC 23, when one of the data packets from switch is sent into one of the buffer units in the buffer stack 20. Obviously, the PPC 23 up-count how many data packets are intended to be sent to the one of N ports so as to have a maximum safety level to be a port threshold for allowing of the data packets to be sent the seitch.

One of N comparators 241 in the alarm units 24 is for judging the status of the alarm units and sending an triggering message to one of N signal generators 242 when an alarming stage is alarmed. The one of N signal generators 242 is to be triggered by the triggering message for sending a flow control signal to another one of N ports corresponding to the source port coding number of a data packet.

Assuming that a data packet is transmitted from any source end and received and stored into one of a plurality of buffer units in the buffer stack 20 in switch 2, the processing progress in the FCSS 21 is described in detail as the following description.

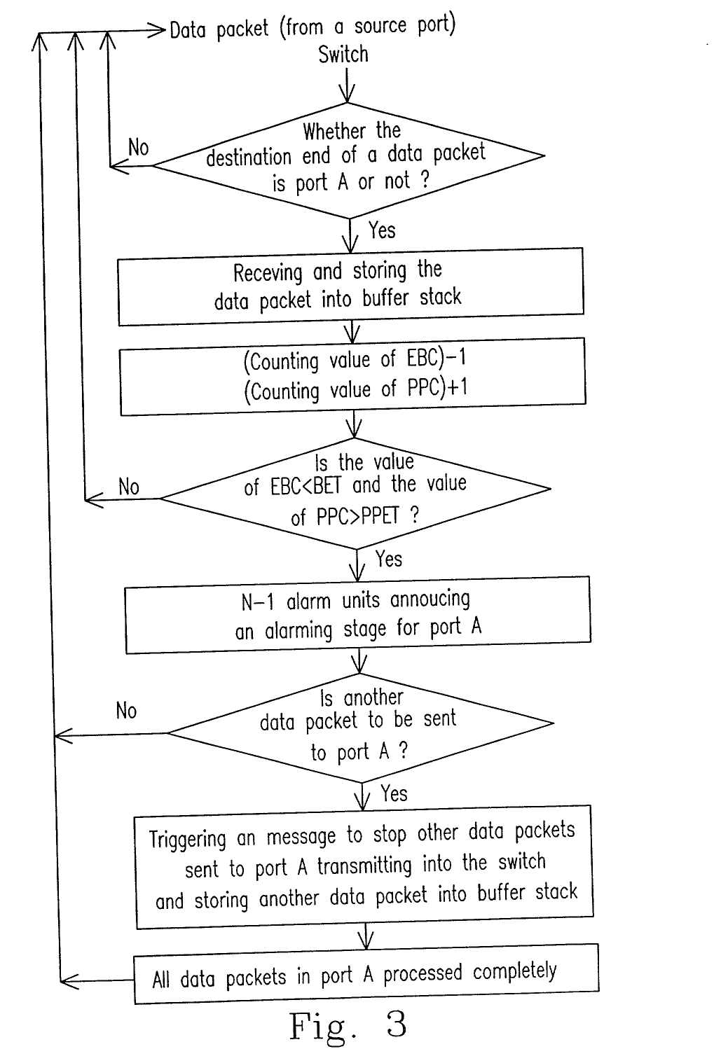

As shown in FIG. 2 and FIG. 3, when the network transmits a data packet to the switch, the switch 2 will send the data packet to a port A (N≧A≧1) according to the destination port coding number recorded in the data packet being port A. FCSS 21 will be immediately reacted to deduct 1 from EBC 22 and add 1 to PPCA, wherein PPCA means one of the PPC 23 corresponding to port A. As the data packets are continued to be sent to port A, FCSS 21 will respectively examine and compute the counter values of EBC 22 and the PPCA at real time.

When the counter value of the EBC 22 is less than the BT as is defined by a user by presetting a value therein and the counter value of the PPCA is greater than the PT as is also defined by a user by presetting a port threshold value therein, and the BT and PT both are described above, then (N−1) alarm units except a alarm unit A corresponding to port A will be alarmed in an alarming state. The alarming state is for informing the switch that the data packets to be sent to port A will be overfilled.

On the other hand, after the alarming state corresponding to the port A is alarmed, if a second data packet from port B is found also to be sent to the port A, one of N comparators 241 in alarm unit B corresponding to port B will process a comparative movement to trigger a triggering message. Then the triggering message will be sent to one of N signal generators for sending a flow control signal to a port corresponding to the port B to inform port B and other source ends among the network connected with the port B to stop transmitting other data packets to be transmitted to port A into the switch 2. As a result, the data packets to be transmitted and exchanged in the switch will be in a effectively guard by the FCSS 21. Furthermore, the circulating of the data packets in the switch will no longer be congested as in the control of the FCSS 21. In addition, the second data packet will be still transmitted into another one of the buffer units in the buffer stack 20 and recorded by deducting 1 from EBC 22 and adding 1 to the one of PPCA as described above.

N (N−1) port-to-port counters is needed according to prior art; however, the present invention needs only N port counters which has less than N(N−1)-N counters. As can be seen, the present invention can greatly reduce the number of counters to simplify the complex designs of the hardware by reducing the numbers of the electric circuit components. Moreover, the preferred flow control system disclosed in the present invention rectifies the none real time problem by executing the flow control signal on real time to control a flux of a port. Thus, the congestion by data packets transmitted in a switch can be effectively dissolved by the flow control system of the present invention.

Additional advantages and modification will readily occur to those skilled in the art. Therefore, the invention in it broad aspects is not limited to the specific details, and representative devices shown and described herein. Accordingly various modification may be made with out departing from the spirit or scope of the general inventive concepts as defined by appended claims and their equivalents.

What we claim is:

1. A control signal system in a switch including N ports and a buffer for registering data packets comprising:
an empty buffer counter for counting how much space said buffer remains available;
N port-packet-counters for respectively counting how many said data packets in said buffer are intended to be respectively sent to specific ones of said N ports.

2. The control signal system in a switch as set forth in claim 1, wherein said buffer stack is a buffer stack comprising a plurality of buffer units therein.

3. The control signal system in a switch as set forth in claim 2, wherein each of said buffer units is to receive and store a data packet sent from network to be sent to a specific port in said switch.

4. The control signal system in a switch as set forth in claim 1, wherein said control signal system is a flow control signal system for controlling a flux of said data packet to be sent to said specific port.

5. The control signal system in a switch as set forth in claim 4, wherein said flow control signal system further comprises an alarming device for alarming that said N ports have reached a threshold state.

6. The control signal system in a switch as set forth in claim 5, wherein said alarming device includes N alarm units is for respectively alarming that said N ports reached threshold states.

7. The control signal system in a switch as set forth in claim 6, wherein said empty buffer counter has a counting value less than a preset threshold value and a specific one of said N port-packets counters has a counting value greater than a threshold value preset therein.

8. The control signal system in a switch as set forth in claim 6, wherein said N alarm units respectively comprises N comparators and N signal generators.

9. The control signal system in a switch as set forth in claim 8, wherein each of said N comparators sends a triggering message corresponding to said threshold state to respective one of said N signal generators after said alarm units respectively alarms.

10. The control signal system in a switch as set forth in claim 8, wherein said respective one of said N signal generators is triggered by said triggering message for sending a flow control signal to all said N ports except said specific port.

11. The control signal system in a switch as set forth in claim 1, wherein said N ports are output/input ports to be outputted/inputted said data packets through said N ports.

12. A method for controlling data packets transmitted in a control signal system in a switch having N ports and a buffer therein, comprising steps of:
(a) sending said data packet to be sent to a specific one of said ports and stored into said buffer into said switch;
(b) initiating and controlling a flux of said data packets to be sent to said specific port
(c) causing said switch into an alarming an alarming state when said specific port will be overfilled with said data packets;
(d) finding another data packet from another port of said N ports to be sent to said specific port and triggering a triggering message to stop said another port from sending any data packet to said specific port;
(e) going back to step (a) after said alarming state corresponding to said specific port is removed and repeating said step (a) to said step (e) to process said data packets to be sent to said specific port until all data packets in said switch have been processed.

13. The method as set forth in claim 12, before said step (a), further comprising a step of sending said data packet from a network.

14. The method as set forth in claim 12, wherein said step (b) further comprises a counting sub-step executed by an empty buffer counter disposed in said system for counting how much space said buffer remains available and one of N port-packet counters for counting how many data packets in said buffer are intended to be sent to said specific port to control said flux.

15. The method as set forth in claim 14, wherein said counting sub-step is to deduct 1 from said empty buffer counter and add 1 to said one of N port-packet-counters corresponding to said specific port.

16. The method as set forth in claim 16, wherein said counting step is to respectively compute whether said empty buffer counter has a counting value less than a threshold value preset therein and said one of said port-packet-counters has a specific counting value greater than a specific threshold value preset therein.

17. The method as set forth in claim 12, wherein said alarming state is caused by an alarm device which comprises N alarming units for respectively alarming that respective said N ports have a respective said flux to overfill said respective N ports.

18. The method as set forth in claim 17, wherein one of said N alarming units alarms that said specific port will be overfilled.

19. The method as set forth in claim 17, wherein said N alarm units respectively comprises of N comparators for triggering said triggering message and N signal generators respectively triggered by said N comparators for respectively sending flow control signals to all said N ports except said specific port.

20. The method as set forth in claim 19, wherein said triggering message is to stop any source end in different network connected with said switch from transmitting said data packets into said switch.

21. The method as set forth in claim 12, before said step (d), further comprising a step of examining said N ports except for said specific port whether there is said another data packet to be sent to said specific port.

22. The method as set forth in claim 21, after said step (c), further comprising a step of sending and storing said another data packet into said buffer.

23. A controlling medium for controlling a transmission of data packets in a flow control signal system in a switch having N ports and a buffer therein comprising:
a storing means for receiving said data packets from a network to be sent to a specific port and storing in said buffer;
a computing means for counting a flux of said data packet to be sent to said specific port;
an alarming means for causing an alarming state for preventing said specific port from being overfilled up with said data packets;
a triggering means for triggering a message to stop any data packet to be sent to said specific port from being transmitted into said switch; and
a processing means for processing said data packets transmitted to said specific port until all data packets in said switch have been processed.

24. The medium as set forth in claim 23, wherein said control signal system further comprises respective N alarming units for respectively alarming said switch from being overfilled with said data packets to be sent to said N ports.

25. The medium as set forth in claim 23, wherein said flux in said computing means is down-counted by an empty buffer counter counting how much space in said buffer remains available and up-counted by one of N port-packet-counters counting how many said data packets in said buffer are intended to be send to said specific port.

26. The medium as set forth in claim 25, wherein said empty buffer counter comprises a preset buffer threshold value denoting a minimum safety level for allowing said data packets to be sent to said switch.

27. The medium as set forth in claim 26, wherein said one of N port-packet counters comprises a respective port threshold value denoting a maximum safety level for allowing of said data packets to be sent to a corresponding one of said N ports.

28. The medium as set forth in claim 27, wherein said alarming state is established when said empty buffer counts is less than said preset buffer threshold and said one of said N port-packet counters counts is greater than said respective port threshold value.

29. The medium as set forth in claim 23, wherein said message in said triggering means is triggered by another data packet come from a second port in said switch to be sent to said specific port

30. The medium as set forth in claim 29, wherein said message is sent by one of comparators respectively set in said system corresponding to said second port.

31. The medium as set forth in claim 30, wherein said message is to be sent to one of signal generators corresponding to said one of said comparators.
